(19) United States
(12) Patent Application Publication
(10) Pub. No.: US 2011/0243492 A1
(43) Pub. Date: Oct. 6, 2011

(54) SILICON BASED OPTICAL MODULATORS AND METHODS OF FABRICATING THE SAME

(75) Inventors: Kyoung-won NA, Seoul (KR); Sung-dong Suh, Seoul (KR); Kyoung-ho Ha, Seocho-gu (KR); Seong-gu Kim, Pyeongtaek-si (KR); Jin-kwon Bok, Suwon-si (KR); Dong-jae Shin, Seoul (KR); Ho-chul Ji, Yongin-si (KR); Pil-kyu Kang, Anyang-si (KR); In-sung Joe, Seoul (KR)

(73) Assignee: Samsung Electronics Co., Ltd.

(21) Appl. No.: 13/049,587

(22) Filed: Mar. 16, 2011

(30) Foreign Application Priority Data
Apr. 6, 2010 (KR) 10-2010-0031559

(51) Int. Cl. G02F 1/035; G02F 1/01; G02B 6/26

(52) U.S. Cl. 385/3; 385/1; 264/1.25

(57) ABSTRACT

A silicon based optical modulator apparatus can include a lateral slab on an optical waveguide, the lateral slab protruding beyond side walls of the optical waveguide so that a portion of the optical waveguide protrudes from the lateral slab towards a substrate.

### CROSS-REFERENCE TO RELATED APPLICATIONS

This application claims the benefit of Korean Patent Application No. 10-2010-0031559, filed on Apr. 6, 2010, in the Korean Intellectual Property Office, the disclosure of which is incorporated herein in its entirety by reference.

### BACKGROUND

The inventive concept relates to a silicon based optical modulator, and more particularly, to a small-sized silicon based optical modulator.

Some optical devices are manufactured to have a discrete shape, and are assembled on a printed circuit board (PCB) substrate. This method can be expensive when optical devices are mass-produced, like in the case of electric devices before integrated circuits (ICs) were invented. Thus, recently, active research has been conducted into optical ICs similar to electric ICs.

An optical IC can be a device that is configured by integrating and miniaturizing optical and electric elements having various functions on a single substrate, like an electric IC. Optical elements constituting the optical IC may be largely classified into active elements and passive elements. An active element is an element to which power is supplied, and examples of the active element include a light source, a modulator, and a receiver. A passive element is an element to which power is not supplied, and examples of the passive element include a waveguide, a coupler, a filter, and a multiplexer.

A representative silicon based active element is an optical modulator using a Mach-Zehnder Interferometer, sometimes referred to as a Mach-Zehnder optical modulator. A Mach-Zehnder optical modulator can include an input (an interferometer) and an optical splitter which divides light received from a light source into two inputs each of which is provided to respective optical paths (i.e. waveguides). One of the optical paths conducts the respective light without any modification (i.e. no phase shift) whereas the other optical path can include an optical modulator (i.e., a phase converter) that introduces a phase shift to the respective light. Light from each of the optical paths is combined so that the respective light from the optical paths interfere with one another (constructively or destructively) to provide an output light, which can vary in intensity due to the interference.

### SUMMARY

In some embodiments according to the inventive concept, a silicon based optical modulator can include a lateral slab on an optical waveguide, the lateral slab protruding beyond side walls of the optical waveguide so that a portion of the optical waveguide protrudes from the lateral slab towards a substrate.

In some embodiments according to the inventive concept, the silicon based optical modulator can include a substrate, first and second grating couplers that are on the substrate and are respectively configured to couple an input optical signal to the apparatus and configured to couple an output optical signal from the apparatus. First and second interferometers are respectively coupled to the first and second grating couplers, where the first interferometer is configured to divide the input optical signal into first and second optical signals onto respective first and second optical waveguides, and where the second interferometer is coupled to the first and second optical waveguides and is configured to combine a modified optical signal with the second optical signal to provide the output optical signal to the second grating coupler. The modulator can further include a phase converter that can include a phase converting unit that is coupled in series with the first optical waveguide and is coupled in parallel with the second optical waveguide, where the phase converter unit is configured to modify a phase of the first optical signals to provide the modified optical signal to the second interferometer for combination with the second optical signal, where the phase converting unit includes a lateral slab extending outward from side walls of the first optical waveguide that protrude from the lateral slab toward the substrate.

In some embodiments according to the inventive concept, a silicon based optical modulator can be provided by forming grating couplers and an optical waveguide on a substrate and then forming a lateral slab on the optical waveguide to protrude beyond each side wall the optical waveguide so that a portion of the optical waveguide protrudes from the lateral slab towards the substrate.

### BRIEF DESCRIPTION OF THE DRAWINGS

Exemplary embodiments of the inventive concept will be more clearly understood from the following detailed description taken in conjunction with the accompanying drawings in which:

FIG. 1 is a schematic diagram of a silicon based optical modulator according to an embodiment of the inventive concept;

FIG. 2 is a perspective view of a phase converting unit of a phase converter of the silicon based optical modulator of FIG. 1;

FIGS. 3A -3B are a plan view and a cross-sectional view, respectively, of the phase converting unit of FIG. 2 in some embodiments according to the inventive concept.

FIGS. 4A and 4B are a plan view and a cross-sectional view, respectively, of the phase converting unit of FIG. 2 in some embodiments according to the inventive concept;

FIGS. 5 through 17 are cross-sectional views showing a method of fabricating a silicon based optical modulator, according to an embodiment of the inventive concept;

FIGS. 18 through 20 are cross-sectional views showing a method of fabricating a silicon based optical modulator, according to another embodiment of the inventive concept;

FIGS. 21 through 24 are cross-sectional views showing a method of fabricating a silicon based optical modulator, according to another embodiment of the inventive concept; and

FIGS. 25 through 27 are cross-sectional views showing a method of fabricating a silicon based optical modulator, according to another embodiment of the inventive concept.

### DETAILED DESCRIPTION OF THE EMBODIMENTS ACCORDING TO THE INVENTIVE CONCEPT

Various example embodiments according to the inventive concept will be described more fully hereinafter with reference to the accompanying drawings, in which some example embodiments according to the inventive concept are shown. The present inventive concept may, however, be embodied in many different forms and should not be construed as limited to the example embodiments according to the inventive concept set forth herein. Rather, these example embodiments according to the inventive concept are provided so that this description will be thorough and complete, and will fully convey the scope of the present inventive concept to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, fourth etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments according to the inventive concept only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments according to the inventive concept are described herein with reference to cross-sectional illustrations that are schematic illustrations of idealized example embodiments according to the inventive concept (and intermediate structures). As such, variations from the shapes of the illustrations as a result, for example, of manufacturing techniques and/or tolerances, are to be expected. Thus, example embodiments according to the inventive concept should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

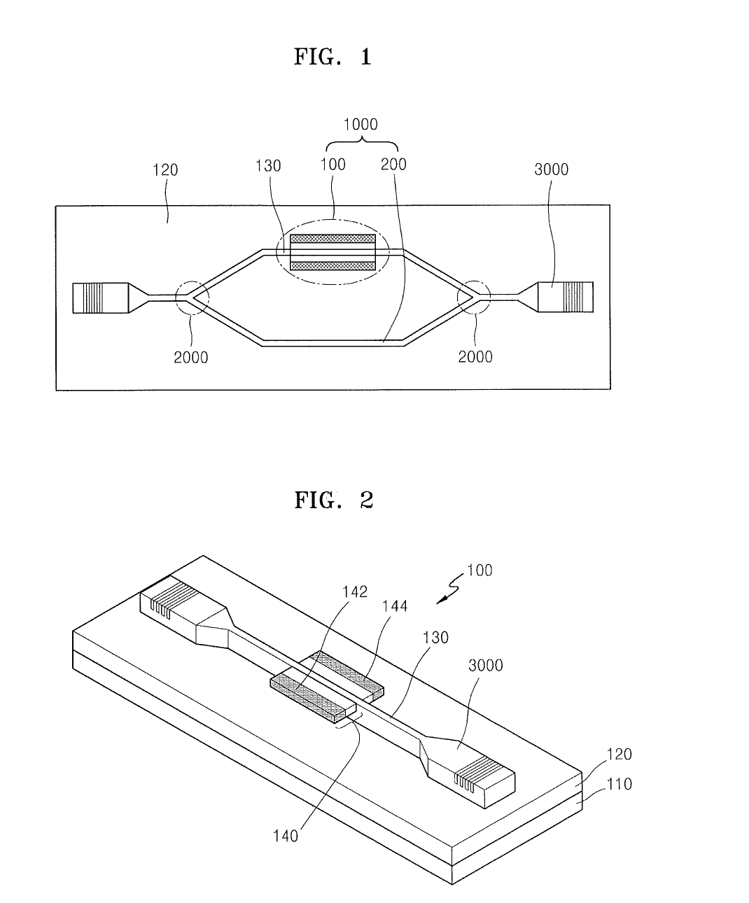

FIG. 1 is a schematic diagram of a silicon based optical modulator according to an embodiment of the inventive concept.

Referring to FIG. 1, the silicon based optical modulator according to the present embodiment includes a phase converter 1000, interferometers 2000, and grating couplers 3000. The phase converter 1000, the interferometers 2000 and the grating couplers 3000 may be formed on a silicon substrate (not shown). In FIG. 1, the interferometers 2000 and the grating couplers 3000 are disposed on an insulating layer 120, for example, a silicon oxide (SiO₂) layer formed on the silicon substrate. That is, the silicon substrate is disposed below the insulating layer 120.

The phase converter 1000 includes a phase converting unit 100 and a path optical waveguide 200. The phase converting unit 100 constitutes a first path of an optical signal, and converts a phase of the optical signal transmitted therethrough. The path optical waveguide 200 constitutes a second optical path of the optical signal, and simply passes the optical signal without converting a phase of the optical signal.

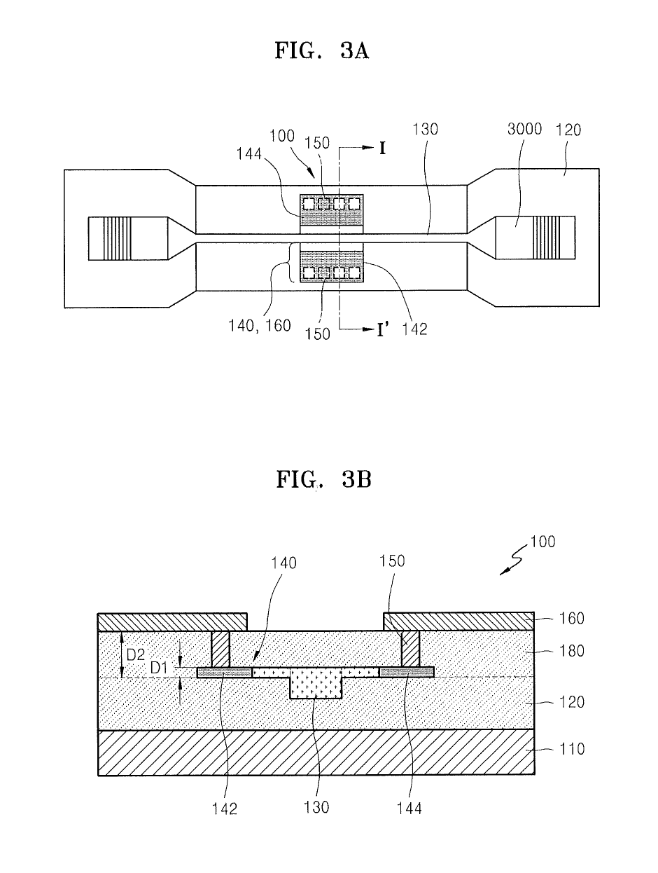

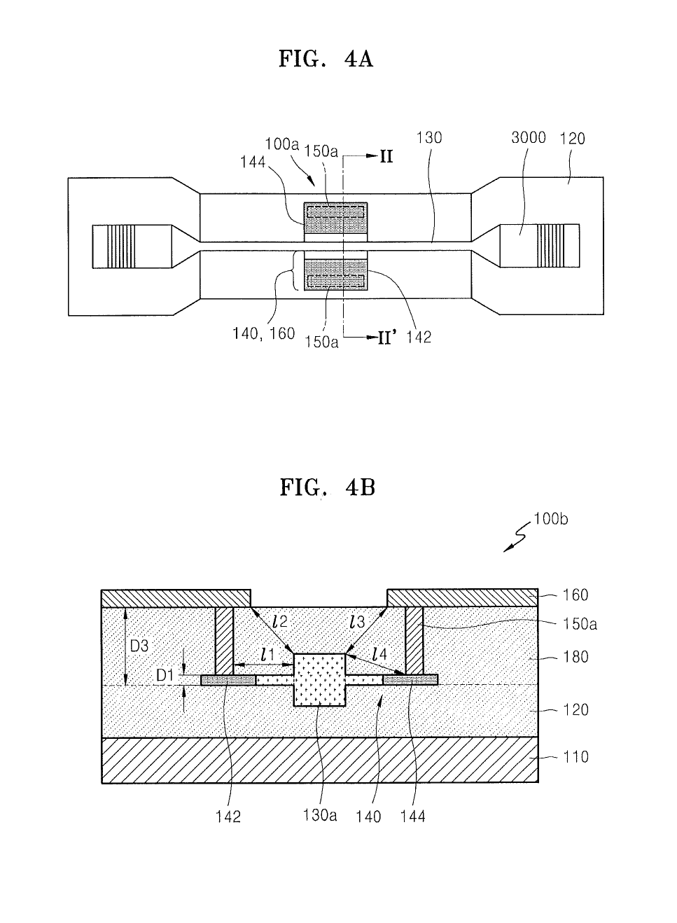

The phase converting unit 100 includes an optical waveguide, and a slab formed on each side of the optical waveguide, in order to convert the phase of the optical signal. Specifically, the optical waveguide is configured to protrude from the slab towards the silicon substrate, that is, the slab is formed on each side of an upper portion of the optical waveguide. The slab may be formed on each side of an intermediate portion of the optical waveguide. The phase converting unit 100 will be described in more detail later, in reference to FIGS. 3A and 4B.

It will be understood that the “slabs” are sometimes described herein as a “lateral slab” (that includes both slabs) that extends in both directions beyond side walls of the optical waveguide. The term lateral includes configurations where the slab extends away from the optical waveguide in a direction that is parallel to the substrate.

The interferometers 2000 are positioned at both where the input light is divided and where light from the two separate waveguides is combined at the output.

The grating couplers 3000 are formed at both ends of the interferometer 2000, respectively, and input or output the optical signal from or to the outside of the silicon based optical modulator.

FIG. 2 is a perspective view of the phase converting unit 100 of the phase converter 1000 of the silicon based optical modulator of FIG. 1. For convenience of description, the grating coupler 3000 and the phase converting unit 100 of FIG. 1 are illustrated in more detail.

Referring to FIG. 2, in the silicon based optical modulator according to the present embodiment, the insulating layer 120, for example, a silicon oxide layer, is formed on a silicon substrate 110, and the phase converting unit 100 and the grating coupler 3000 are formed on the insulating layer 120. Typically, the phase converting unit 100 and the grating coupler 3000 may be formed as an upper silicon layer of a silicon on insulator (SOI) substrate. However, the insulating layer 120 and a monocrystalline silicon layer may be sequentially formed on the silicon substrate 110, and the phase converting unit 100 and the grating coupler 3000 may be formed on (or from) the monocrystalline silicon layer.

The insulating layer 120 functions as a lower clad with respect to an optical waveguide 130 included in the phase converting unit 100 and the grating coupler 3000. In addition, in the case of an actual completed optical modulator, an optical waveguide of the phase converting unit 100, the grating coupler 3000, an interferometer, and the second path are completely covered by an insulating layer. With respect to the optical waveguide 130, a lower insulating layer will be referred to as a lower clad, and an upper insulating layer will be referred to as an upper clad. Typically, the optical waveguide 130 is formed of monocrystalline silicon, and an insulating layers of the lower and upper dads (i.e., lower and upper cladding layers) are formed of silicon oxide.

The phase converting unit 100 includes the optical waveguide 130 and a slab 140. As shown in FIG. 2, the slab 140 is formed on each side of the upper portion of the optical waveguide 130. The slab 140 may be formed on each side of an intermediate portion of the optical waveguide 130. In FIG. 2, as illustrated for convenience, the slab 140 is shown as separate from the insulating layer 120. However, as described above, an entire surface of the phase converting unit 100 is covered by the insulating layer 120, and thus the slab 140 is formed on the insulating layer 120.

A p-type doping region 142 and a n-type doping region 144 that are respectively doped with a p-type ion and a n-type ion may be formed on portions of the slab 140. The p-type doping region 142 and the n-type doping region 144 function as electrodes. Thus, the p-type doping region 142 and the n-type doping region 144 may be connected to an electrode pad (not shown) connected to a power source through a metal contact (not shown). When a current is supplied to the optical waveguide 130 through the p-type doping region 142 and the n-type doping region 144, the refractive index of the optical waveguide 130 may vary resulting in a phase of an optical signal transmitted through the optical waveguide 130 being changed. Accordingly, electrical signals used to modify the refractive index of the optical waveguide 130 are typically provided to the electrodes, but are not shown herein.

FIGS. 3A and 3B are views of the phase converting unit 100 of FIG. 2. In FIGS. 4A and 4B, metal contacts 150 or 150a, and an electrode pad 160 are formed on the slab 140.

Referring to FIG. 3A, the metal contacts 150 that are connected to the P-type doping region 142 and the N-type doping region 144 of the slab 140 are formed on the slab 140 of the phase converting unit 100. The electrode pad 160 is formed on the metal contacts 150. According to the present embodiment, the number of the metal contacts 150 may be determined according to the width of the electrode pad 160. For example, four metal contacts 150 may be formed. The metal contacts 150 may be formed to obtain a sufficient processing margin since the slab 140 is formed on the upper portion of the optical waveguide 130, which will be described in more detail, with reference to FIGS. 3B and 4B.

Referring to FIG. 4A, the phase converting unit 100a of FIG. 3B is similar to the phase converting unit 100 of FIG. 3A, except for the metal contacts 150a. That is, in FIG. 4A, the metal contacts 150a may have an integrated (or unitary) structure having a linear shape so as to correspond to the width of the electrode pad 160 since the slab 140 is formed on the upper portion of the optical waveguide 130, which will be described in more detail, with reference to FIGS. 3B and 4B.

FIGS. 3B and 4B are cross-sectional views of the phase converting unit 100 taken along a line I-I′ of FIG. 3A and a line II-II' of FIG. 4A, respectively.

Referring to FIG. 3B, the phase converting unit 100 includes the silicon substrate 110, a lower clad 120, the optical waveguide 130, the slab 140, the metal contacts 150, the electrode pad 160 and an upper clad 180.

The lower clad 120 and the upper clad 180 are insulating layers, and may be formed of, for example, silicon oxide. According to the present embodiment, the upper clad 180 may be formed to a thickness, D2, of 1 μM or less.

The optical waveguide 130 is formed of monocrystalline silicon, and protrudes from the slab 140 towards the silicon substrate 110. In other words, the slab 140 is formed on each side of the upper portion of the optical waveguide 130. If a SOI substrate is used to form the optical waveguide 130, the optical waveguide 130 is formed by using an upper silicon layer of the SOI substrate. If a silicon bulk substrate is used to form the optical waveguide 130, an insulating layer such as a silicon oxide layer is formed on a substrate, and amorphous silicon or polysilicon is deposited on the insulating layer. After the amorphous silicon or polysilicon is mono-crystallized by using a solid phase epitaxial (SPE) growth process or a laser epitaxial growth (LEG) process, the optical waveguide 130 may be formed of monocrystalline silicon.

The slab 140 may be formed on each side of the upper portion of the optical waveguide 130, as described above, and may be formed to a thickness D1 of, for example, 10 to 100 nm. Likewise, the thickness D1 of the slab 140 may be controlled by forming the slab 140 on the upper portion of the optical waveguide 130. That is, the slab 140 is formed on the upper portion of the optical waveguide 130 and an adjacent surface of the lower clad 120, depositing amorphous silicon or polysilicon to a predetermined thickness on the optical waveguide 130 and the insulating layer (lower clad 120), and then patterning a monocrystalline silicon layer that is monocrystallized by using an SPE growth process or an LEG process, and thus the thickness of the slab 140 may be controlled. Here, the portion of the monocrystalline silicon layer disposed on the upper surface of the optical waveguide 130 comprises the slab 140.

According to FIG. 3B, the optical waveguide 130 protrudes from the lateral slab 142/144 toward the substrate 110 and the lateral slab 142/144 extends beyond side walls of the optical waveguide 130 According to FIG. 4B, the optical waveguide 130 includes a lower portion that protrudes from the lateral slab 142/144 toward the substrate 110 and an upper portion that protrudes from the lateral slab 142/144 opposite the substrate 11o so that the lateral slab 142/144 and the upper portion of the optical waveguide have a cross-section that is hat shaped. As further shown in FIG. 4B, the lateral slab 142/144 extends beyond side walls of the optical waveguide 130 that includes both the upper and lower portions of the optical waveguide 130.

As appreciated by the present inventors, a slab can be formed by etching both side surfaces of a thick silicon layer constituting an optical waveguide, and therefore, since the etching is performed without a stopper, the thickness of the slab may not be easily controlled. However, in some embodiments according to the inventive concept, the thickness of the slab 140 may be controlled by using a deposition method and a monocrystallizing method to form the slab 140.

The p-type doping region 142 and the n-type doping region 144 that function as electrodes may be formed on both lateral portions of the slab 140 by using an ion doping method.

The metal contacts 150 are formed on the p-type doping region 142 and the n-type doping region 144 of the slab 140. Each metal contact 150 is formed by forming a via hole in the upper clad 180 and filling the via hole with a metal material. For example, each metal contact 150 may be formed by forming a respective via hole, depositing barrier metal on a surface of the via hole and then filling each via hole with tungsten (W).

As shown in FIGS. 3A and 4A, a predetermined number of metal contacts 150 may be formed, or may have an integrated structure having a linear shape, so as to correspond to the width of the electrode pad 160 formed on the metal contacts 150. According to the present embodiment, the upper clad 180 may be formed, for example, to a thickness of about 1 μm or less, as described above. Thus, a via hole may be more easily formed in the upper clad 180, the via hole may have various structures, for example, a single hole structure having a linear shape, and a contact resistance at each metal contact 150 may be reduced.

When the upper clad 180 is relatively thin, since a portion of the upper clad 180 to be etched is thin, an etch profile may be approximately vertical. In addition, a sufficient processing margin may be obtained. Based on the vertical profile, the via hole may be uniformly filled with metal. Due to the sufficient processing margin, the via hole may have various structures. Due to the uniformity of the metal filled in the via hole and various structures of the via hole, for example, a single hole structure having a linear shape, a contact resistance at each metal contact 150 may be reduced resulting in the amount of power used for phase conversion being reduced. Furthermore, when the upper clad 180 is thin, since a portion of the upper clad 180 to be etched is thin, an etching amount may be reduced to reduce the likelihood of damaging a lower portion of the slab 140 due to etching. As a result, the optical properties of an optical waveguide, that is, phase conversion performance may be improved.

According to the present embodiment, the reason why the upper clad 180 can be formed to be thin will now be described. As appreciated by the present inventors, phase conversion performance of the optical waveguide 130 may be improved if the metal contacts 150 and the electrode pad 160 can be spaced apart from the optical waveguide 130 by a predetermined distance. For example, when a distance of 1 μm or more is ensured, the electromagnetic influence of the metal contacts 150 and the electrode pad 160 on the optical waveguide 130 may be reduced, and thus the optical properties in the optical waveguide 130 may be maintained. According to the present embodiment, since the optical waveguide 130 protrudes towards the silicon substrate 110, although the upper clad 180 is thin, the metal contacts 150 and the electrode pad 160 may be formed while sufficiently ensuring a minimum distance between the optical waveguide 130 and the metal contacts 150 or the electrode pad 160.

Referring to FIG. 4B, a phase converting unit 100b is similar to the phase converting unit 100 of FIG. 3B except for the structure of an optical waveguide 130a and a location of the slab 140.

According to the present embodiment, the phase converting unit 100b is configured so that the optical waveguide 130a has a symmetric shape with respect to the slab 140. That is, the slab 140 is formed at an intermediate location of the optical waveguide 130a. The slab 140 may be slightly offset from an intermediate location of optical waveguide 130a, rather than being formed at an exactly intermediate location.

By forming the slab 140 at an intermediate location of the optical waveguide 130a, a current may be symmetrically supplied from the slab 140 to the optical waveguide 130a, thereby improving the optical property, that is, the phase conversion property, in the optical waveguide 130a. As described with reference to FIG. 3B, since a minimum separation, for example, about 1 μm can be provided between the optical waveguide 130a and the metal contacts 150a or the electrode pad 160, the upper clad 180 may be formed to provide the minimum separation. In FIG. 4B, distances 11 and 14 between the optical waveguide 130a and the metal contacts 150a, and distances 12 and 13 between the optical waveguide 130a and the electrode pads 160 are indicated.

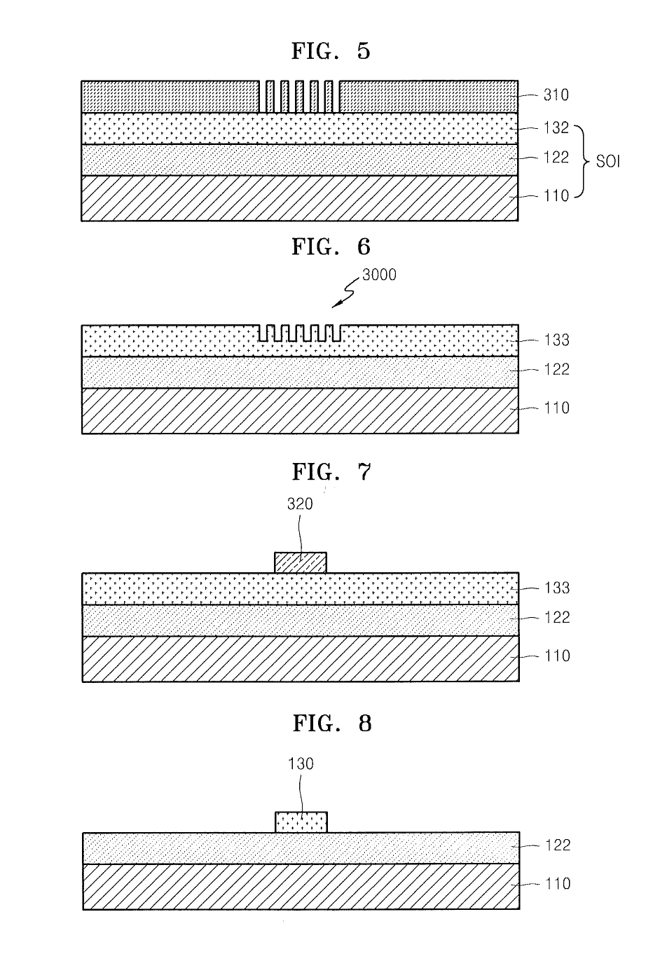

FIGS. 5 through 17 are cross-sectional views showing a method of fabricating a silicon based optical modulator, according to an embodiment of the inventive concept, and show a method of fabricating the silicon based optical modulator including the phase converting unit 100 of FIG. 3B.

Referring to FIG. 5, a photoresist (PR) pattern 310 for forming a grating coupler 3000 (see FIG. 6) is formed on a SOI substrate. The SOI substrate includes a lower silicon layer 110, an insulating layer 122 and an upper silicon layer 132. The lower silicon layer 110 and the upper silicon layer 132 may each be a monocrystalline silicon layer, and the insulating layer 122 may be a silicon oxide layer.

Referring to FIG. 6, the upper silicon layer 132 is etched by using the PR pattern 310 as a mask to form the grating coupler 3000 in an upper silicon layer 133.

Referring to FIG. 7, a PR pattern 320 is formed on the upper silicon layer 133 in order to form the optical waveguide 130 (See FIG. 8) included in the silicon based optical modulator.

Referring to FIG. 8, the upper silicon layer 133 is etched by using the PR pattern 320 as a mask to form the optical waveguide 130 on the insulating layer 122. The optical waveguides 130 may include all optical waveguides included in the silicon based optical modulator, that is, optical waveguides included in a grating coupler, an interferometer, a phase converter, and so on. That is, in the present operation, all optical waveguide to be formed in the silicon based optical modulator are simultaneously formed by using appropriate PR patterns.

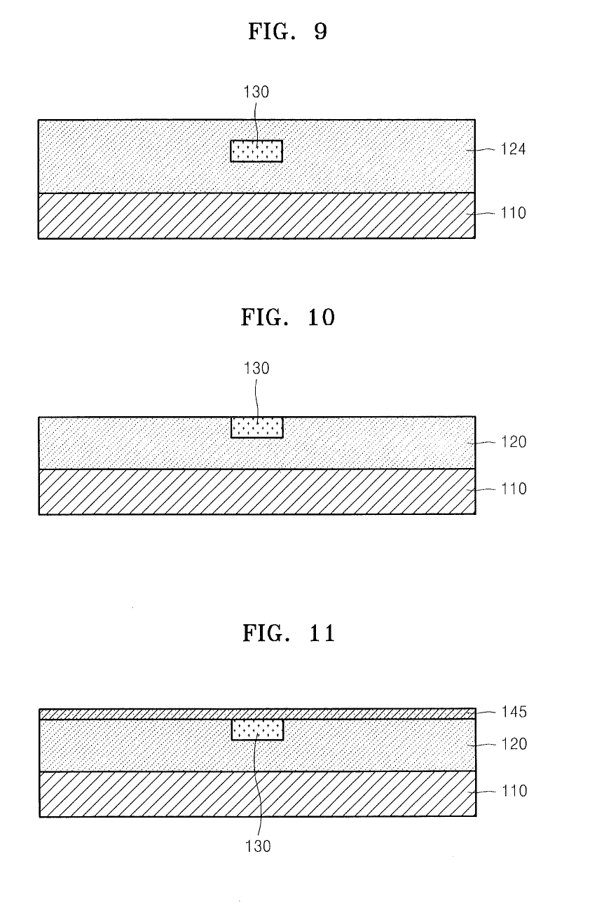

Referring to FIG. 9, the same insulating material as that of the insulating layer 122, for example, silicon oxide, is deposited on the insulating layer 122 to a predetermined thickness so as to cover the optical waveguide 130. In this case, a reference numeral 124 indicates an entire insulating layer formed by depositing an insulating material and including the insulating layer 122.

Referring to FIG. 10, the entire insulating layer 124 is planarized by using a chemical mechanical polishing (CMP) method so as to expose an upper surface of the optical waveguide 130. After the CMP method is performed on the entire insulating layer 124, the remaining portion of the entire insulating layer 124 is the lower clad 120.

Referring to FIG. 11, an amorphous silicon or polysilicon layer 145 is formed on an entire region of the optical waveguide 130 and the lower clad 120, or may be partially formed on the optical waveguide 130 and the lower clad 120 so as to correspond to the phase converting unit 100. The amorphous silicon or polysilicon layer 145 may be formed to an appropriate thickness in consideration of the thickness of the slab 140 to be formed later. As appreciated by the present inventors, since the amorphous silicon or polysilicon layer 145 is formed by using a deposition method, the thickness of the amorphous silicon or polysilicon layer 145 may be more easily controlled, and thus the thickness of the slab 140 may be more easily controlled.

Referring to FIG. 12, the amorphous silicon or polysilicon layer 145 is monocrystallized by using an SPE growth process or an LEG process to form a monocrystalline silicon layer 145a.

Referring to FIG. 13, the monocrystalline silicon layer 145a is etched by using a PR pattern (not shown) as a mask so as to form the slab 140 having a desired shape. Since the slab 140 is formed by etching the monocrystalline silicon layer 145a, the slab 140 is also formed of monocrystalline silicon. Here, a portion of the monocrystalline silicon layer disposed on the upper surface of the optical waveguide 130 constitutes the optical waveguide 130.

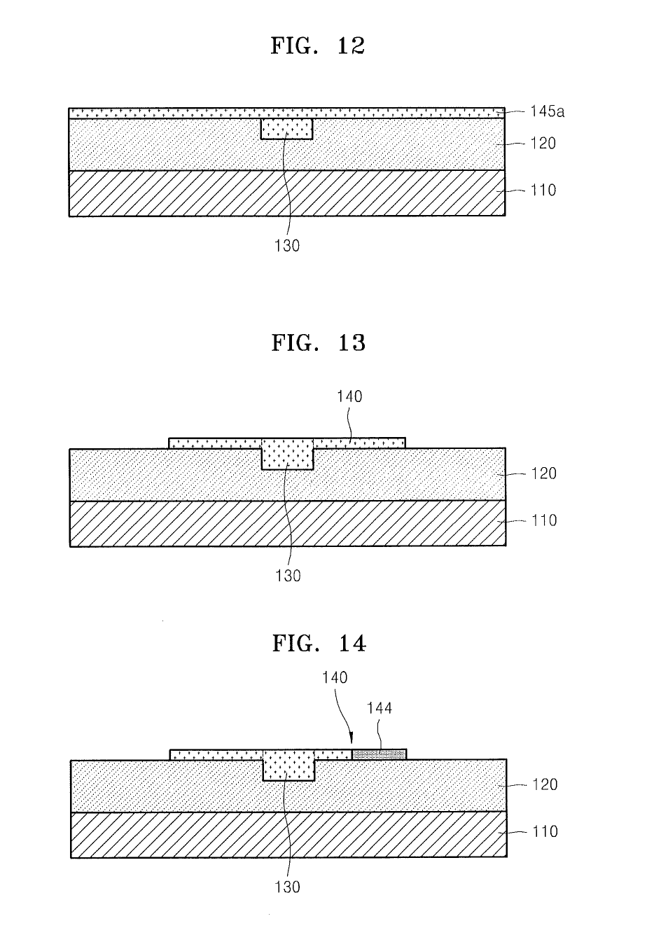

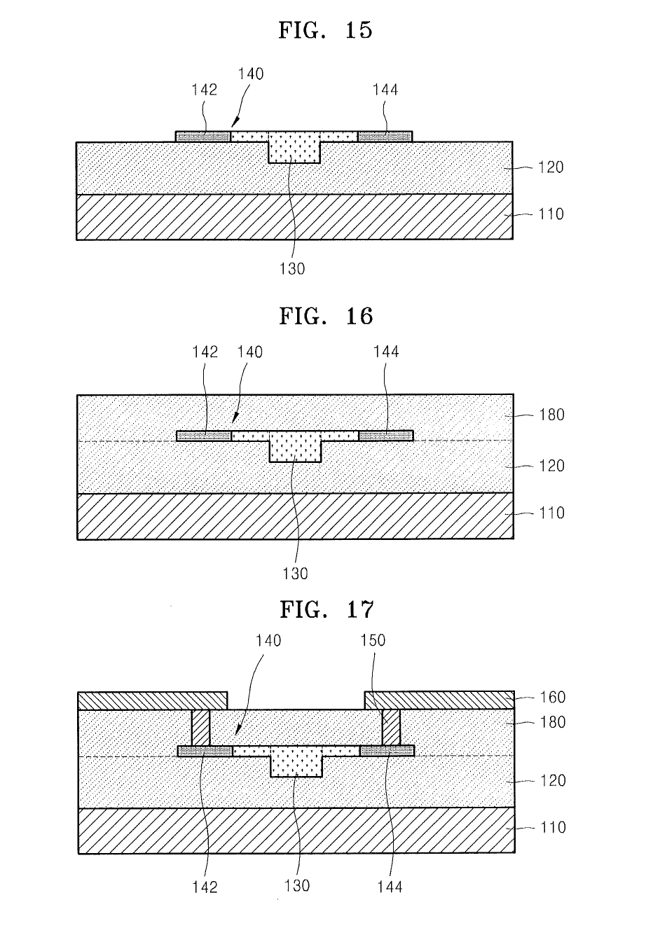

Referring to FIGS. 14 and 15, both lateral portions of the slab 140 are doped with ions by using PR patterns (not shown) to form the p-type doping region 142 and the n-type doping region 144. The locations of the p-type doping region 142 and the n-type doping region 144, and the order in which those regions are formed, may be reversed. When the locations of the p-type doping region 142 and the N-type doping region 144 are reversed, appropriate polarities of power should connected to electrode pads according to polarities of electrodes connected to the p-type doping region 142 and the n-type doping region 144.

Referring to FIG. 16, the upper clad 180 is formed on an entire surface of the lower clad 120, the optical waveguide 130 and the slab 140. As described above, since the optical waveguide 130 protrudes towards the silicon substrate 110, the upper clad 180 may be formed to have a small thickness of, for example, 1 μm or less.

Referring to FIG. 17, after the upper clad 180 is formed, the metal contacts 150 that are respectively connected to the p-type doping region 142 and the n-type doping region 144 of the slab 140 are formed, and then the electrode pads 160 that are respectively connected to the metal contacts 150 are formed.

As described above, the metal contacts 150 are formed by forming a predetermined number of a plurality of via holes or a single via hole having a linear shape, which corresponds to the width of the electrode pad 160, on the p-type doping region 142 and the n-type doping region 144 through the upper clad 180, depositing barrier metal on a surface of the via hole and then filling the via hole with metal such as tungsten (W). After the via hole is filled with metal, a CMP method is performed for planarization. In addition, according to the shape of the via hole, a plurality of unit metal contacts each having a predetermined shape or an integrated metal contact having a linear shape may be formed.

After the metal contacts 150 are formed, a conductive material, for example, aluminum (Al) is coated on an entire surface of the upper clad 180, and is patterned to a predetermined shape to form the electrode pads 160.

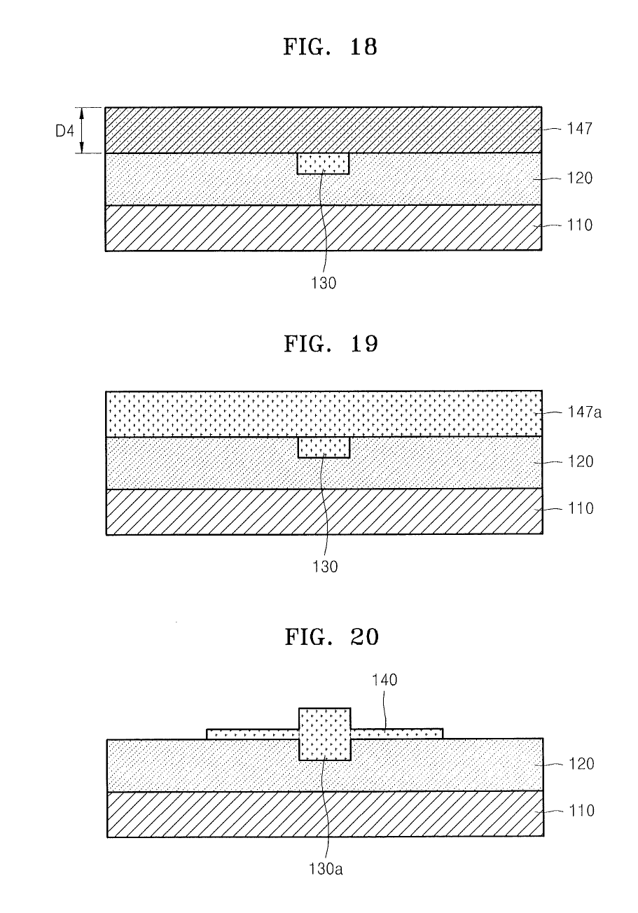

FIGS. 18 through 20 are cross-sectional views showing a method of fabricating a silicon based optical modulator, according to another embodiment of the inventive concept, the silicon based optical modulator including the phase converting unit 100b of FIG. 4A. Operations according to the present embodiment that are the same as those of the method of FIGS. 5 through 17, are not repeated here.

An operation of FIG. 18 corresponds to the operation of FIG. 11. Referring to FIG. 18, an amorphous silicon or polysilicon layer 147 is formed on an entire surface of the optical waveguide 130 and the lower clad 120, or is partially formed on the optical waveguide 130 and the lower clad 120 so as to correspond to the phase converting unit 100b. However, unlike in FIG. 11, the amorphous silicon or polysilicon layer 147 is formed to be relatively thick. That is, the thickness D4 of the amorphous silicon or polysilicon layer 147 is greater than the thickness of the amorphous silicon or polysilicon layer 145 of FIG. 11 in order to form the optical waveguide 130a to also protrude upwards with respect to the slab 140. That is, the amorphous silicon or polysilicon layer 147 may be formed to an appropriate thickness in consideration of the thickness of the slab 140 to be formed later and the thickness of the optical waveguide 130a that protrudes upwards.

An operation of FIG. 19 corresponds to the operation of FIG. 12. Referring to FIG. 19, the amorphous silicon or polysilicon layer 147 is mono-crystallized by using an SPE process or an LEG process to form a monocrystalline silicon layer 147a.

An operation of FIG. 20 corresponds to the operation of FIG. 13. Referring to FIG. 20, the monocrystalline silicon layer 147a is etched by using a PR pattern (not shown) as a mask so as to form the slab 140 having a desired shape. According to the present embodiment, the monocrystalline silicon layer 147a is formed to be shaped like a hat, and accordingly a portion of the monocrystalline silicon layer 147a on the upper surface of the optical waveguide 130 constitutes the optical waveguide 130a, and lateral thin portions of the monocrystalline silicon layer 147a constitutes the slab 140. Likewise, the slab 140 is formed at an intermediate location of the optical waveguide 130a, and thus a current is symmetrically supplied from the slab 140 to the optical waveguide 130a, thereby improving the optical property of the optical waveguide 130a.

Operations prior to the operation of FIG. 18 are the same as the operations of FIGS. 5 through 10, and operations subsequent to the operation of FIG. 20 are the same as the operations of FIGS. 13 through 17.

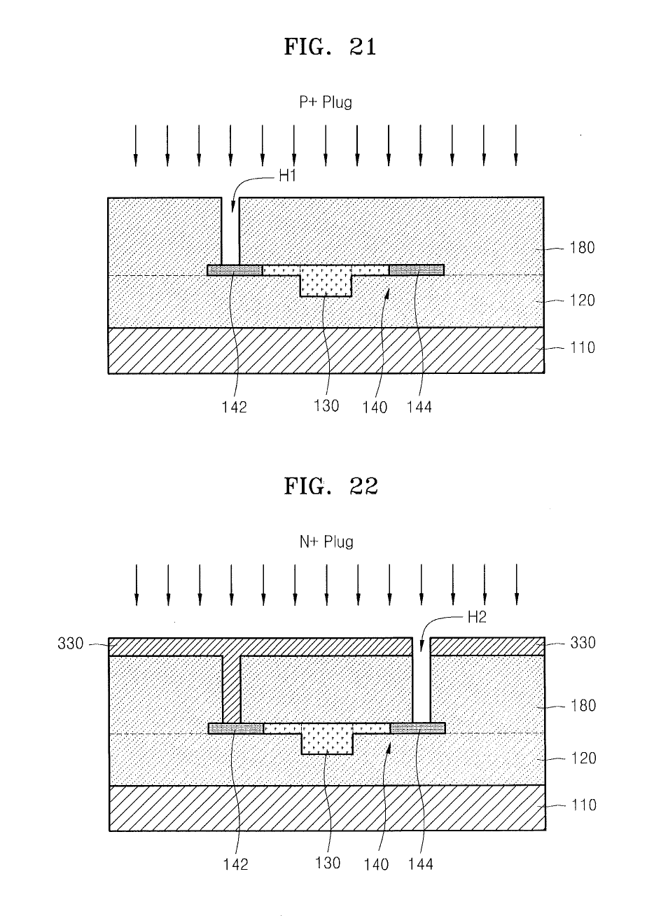

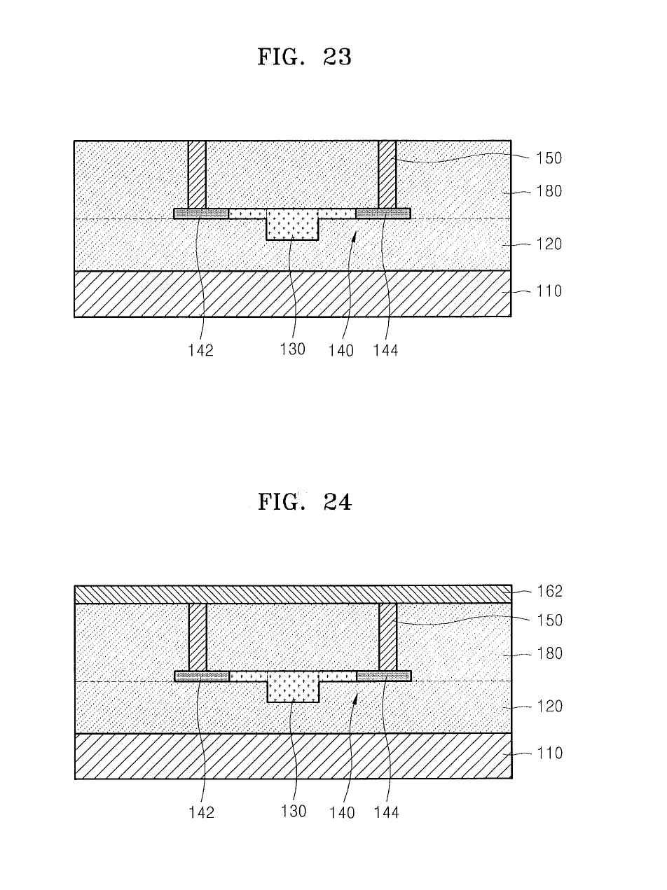

FIGS. 21 through 24 are cross-sectional views showing a method of fabricating a silicon based optical modulator, according to another embodiment of the inventive concept, and show operations of forming the metal contacts 150 and the electrode pad 160 in more detail.

Referring to FIG. 21, a via hole H1 for forming a metal contact 150 is formed on the p-type doping region 142 or the n-type doping region 144, for example, the p-type doping region 142. In addition, the resulting structure is cleaned, and p-type ions (P+) are implanted into the via hole H1 in order to recover the p-type doping region 142 of the slab 140 from damage caused during the formation of the via hole H1. Thus, a reduction in the p-type ions of the P-type doping region 142 during the formation of the via hole H1 may be compensated for.

Referring to FIG. 7B, a via hole H2 is formed on the n-type doping region 142. The resulting structure is cleaned and n-type ions (N+) are implanted into the via hole H2 in order to repair some damage to the n-type doping region 144 caused during the formation of the via hole H2. In this case, a PR pattern 330 used for forming the via hole H2 may not be removed, and the PR pattern 330 is used as a mask for implanting the n-type ions (N+) so that the n-type ions may not be implanted into the p-type doping region 142.

Referring to FIG. 7C, after the cleaning and the ion doping are performed, the PR pattern 330 is removed, the via holes H1 and H2 are filled with metal to form the metal contacts 150.

Referring to FIG. 7D, metal, for example, aluminum (Al) is coated on an entire surface of the upper clad 180 to form an Al layer 162. The Al layer 162 can be patterned to form the electrode pads 160.

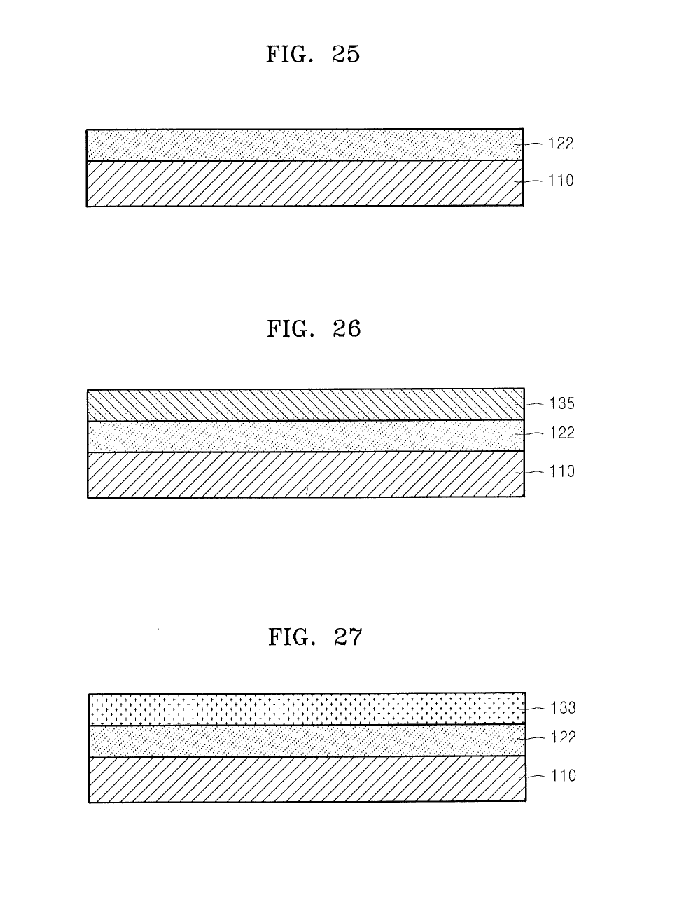

FIGS. 25 through 27 are cross-sectional views showing a method of fabricating a silicon based optical modulator, according to another embodiment of the inventive concept, by using a silicon bulk substrate instead of a SOI substrate.

Referring to FIG. 8A, the insulating layer 122 is formed on the silicon substrate 110. The insulating layer 122 may be formed of, for example, silicon oxide. The insulating layer 122 may be formed on an entire surface of the silicon substrate 110, or may be formed only on a portion of the silicon substrate 110 so as to correspond to an optical waveguide to be formed later.

Referring to FIG. 26, amorphous silicon or polysilicon is deposited on the insulating layer 122 to form an amorphous silicon or polysilicon layer 135. Since the amorphous silicon or polysilicon layer 135 is used to provide the optical waveguide, the amorphous silicon or polysilicon layer 135 may be formed to an appropriate thickness in consideration of the structure of the optical waveguide.

Referring to FIG. 27, the amorphous silicon or polysilicon layer 135 is monocrystallized by using an SPE growth process or an LEG process to form a monocrystalline silicon layer 133. Then, the same operations as those of FIGS. 5 through 11 can be performed.

While the inventive concept has been particularly shown and described with reference to exemplary embodiments thereof, it will be understood that various changes in form and details may be made therein without departing from the spirit and scope of the following claims.

What is claimed is:

1. An apparatus comprising:
a substrate;
first and second grating couplers, on the substrate, respectively configured to couple an input optical signal to the apparatus and configured to couple an output optical signal from the apparatus;
first and second interferometers, respectively coupled to the first and second grating couplers, the first interferometer configured to divide the input optical signal into first and second optical signals onto respective first and second optical waveguides, the second interferometer coupled to the first and second optical waveguides and configured to combine a modified optical signal with the second optical signal to provide the output optical signal to the second grating coupler; and
a phase converter including:
a phase converting unit coupled in series with the first optical waveguide and coupled in parallel with the second optical waveguide, the phase converter unit configured to modify a phase of the first optical signal to provide the modified optical signal to the second interferometer for combination with the second optical signal, the phase converting unit including a lateral slab extending outward from side walls of the first optical waveguide that protrudes from the lateral slab toward the substrate.

2. The apparatus of claim 1, wherein the phase converting unit comprises:
a lower clad on the substrate;
the first optical waveguide on the lower clad;
wherein the lateral slab comprises slabs respectively extending beyond each of the side walls of the first optical waveguide;
an upper clad on the lower clad, on the first optical waveguide and on the lateral slab; and
an electrode pad on the upper clad and electrically connected to the lateral slab.

3. The apparatus of claim 2, wherein the electrode pad is connected to the lateral slab by a metal contact through the upper clad to contact the lateral slab, and wherein the lateral slab comprises a p-type doping region and a n-type doping region each of which contacts the metal contact.

4. The apparatus of claim 3, wherein the metal contact has an integrated unitary structure and a linear shape to correspond to a width of the electrode pad, or a plurality of unit metal contacts each having a predetermined shape to correspond to the width of the electrode pad.

5. The apparatus of claim 2, wherein a thickness of the lateral slab is in a range between about 10 nm and about 100 nm; and
wherein a thickness of the upper clad is about 1 micrometer.

6. The apparatus of claim 2, wherein the lateral slab is on an upper surface of the first optical waveguide, or the lateral slab protrudes from an intermediate portion of the side walls of the first optical waveguide.

7. The apparatus of claim 6, wherein when the lateral slab protrudes from an intermediate portion of the side walls of the first optical waveguide, the first optical waveguide protrudes toward the substrate and toward the electrode pad with respect to the slab.

8. The apparatus of claim 2, wherein the first optical waveguide and the slab comprise monocrystalline silicon on the lower clad.

9. The apparatus of claim 1, wherein the substrate comprises a silicon on insulator (SOI) substrate comprising a lower silicon layer, an insulating layer, and an upper silicon layer.

10. The apparatus of claim 9, wherein the phase converting unit comprises:
a lower clad comprises the insulating layer;
the first optical waveguide comprises the upper silicon layer on the lower clad;
a lateral slab protruding beyond the side walls ;
an upper clad on the lower clad, on the first optical waveguide and on the lateral slab; and
an electrode pad on the upper clad and electrically connected to the lateral slab.

11. The apparatus of claim 10, wherein the lateral slab comprises monocrystalline silicon formed by mono-crystallizing amorphous silicon or polysilicon formed on the lower clad.

12. A method comprising:
forming grating couplers and an optical waveguide on a substrate; and then
forming a lateral slab on the optical waveguide to protrude beyond each side wall of the optical waveguide so that a portion of the optical waveguide protrudes from the lateral slab towards the substrate.

13. The method of claim 12 wherein the portion of the optical waveguide that protrudes from the lateral slab towards the substrate comprises a lower portion of the optical waveguide, the method further comprising:
forming an upper portion of the optical waveguide on the lateral slab protruding from the lateral slab away from the substrate opposite the lower portion of the optical waveguide.

14. The method according to claim 12 wherein forming the lateral slab on the optical waveguide to protrude beyond each side wall comprises:
depositing silicon on an exposed upper surface of the optical waveguide; and
mono-crystallizing the silicon using a solid phase epitaxial growth process or a laser epitaxial growth process.

15. The method according to claim 13 wherein forming the lateral slab on the optical waveguide to protrude beyond each side wall and forming the upper portion of the optical waveguide comprises:
depositing silicon on an exposed upper surface of the lower portion of the optical waveguide to a thickness sufficient to provide for the formation of the lateral slab and the upper portion of the optical waveguide;
mono-crystallizing the silicon using a solid phase epitaxial growth process or a laser epitaxial growth process to provide mono-crystallized silicon; and then
patterning the mono-crystallized silicon to form the upper portion of the waveguide and the lateral slab.

16. The method according to claim 15 wherein patterning the upper portion of the waveguide and the lateral slab comprises patterning the upper portion of the waveguide and the lateral slab to have a hat shaped cross-section from the mono-crystallized silicon.

17. The method according to claim 12 further comprising:
forming an upper clad on the lateral slab;
forming contacts through the upper clad to expose a portion of the lateral slab; and
forming electrodes on the upper clad coupled to the contacts so that electrodes and the contacts are spaced apart from the optical waveguide by at least about 1 micrometer.

18. The method according to claim 12 wherein forming the lateral slab comprises forming the lateral slab to a thickness in a range between about 10 nm and about 100 nm; and

19. The method according to claim 17 wherein forming the upper clad on the lateral slab comprises forming the upper clad on the lateral slab to a thickness of about 1 micrometer.

20. An apparatus comprising:
a lateral slab of a silicon based optical modulator on an optical waveguide, the lateral slab protruding beyond side walls of the optical waveguide so that a portion of the optical waveguide protrudes from the lateral slab towards a substrate.
